(19) United States
(12) Patent Application Publication
(10) Pub. No.: US 2026/0346199 A1
(43) Pub. Date: Nov. 5, 2026

(54) AMBIENT NOx REDUCTION WITH PAINTED WAVY SURFACES

(71) Applicants: Hamid Rahai, Long Beach, CA (US); Ryan Moffit, Long Beach, CA (US); Komal Gada, Long Beach, CA (US); Jeremy Bonifacio, Long Beach, CA (US)

(72) Inventors: Hamid Rahai, Long Beach, CA (US); Ryan Moffit, Long Beach, CA (US); Komal Gada, Long Beach, CA (US); Jeremy Bonifacio, Long Beach, CA (US)

(21) Appl. No.: 19/221,125

(22) Filed: May 28, 2025

Related U.S. Application Data
(60) Provisional application No. 63/800,363, filed on May 5, 2025.

(51) Int. Cl. B01D 53/88; B01D 53/00; B01D 53/86; B01J 21/06; B01J 35/39

(52) U.S. Cl. CPC B01D 53/885; B01D 53/007; B01D 53/8628; B01D 53/8631; B01J 21/063; B01J 35/39; B01D 2255/20707; B01D 2255/802; B01D 2257/404; B01D 2258/06; B01D 2259/804

(57) ABSTRACT

A chemically reactive panel is incorporated into a reactor for use in NOx remediation. The panel uses an optimized surface geometry and is connected to a solar-powered suction fan that forces air over the surface for increased ambient NOx conversion. The system of the present invention is self-sustaining and can be placed at any location with a high concentration of ambient NOx for continuous NOx reduction during daylight hours. Using a transparent cover, the reactor utilizes sunlight and the chemically reactive panel to remove NOx from an airstream using a paint with titanium dioxide (TiO2) nanoparticles.

### CROSS-REFERENCES TO RELATED APPLICATIONS

This application claims priority to U.S. Ser. No. 63/800,363, filed May 5, 2025, the content of which is incorporated by reference herein in their entirety.

### BACKGROUND

Nitrogen oxides (NOx) absorption technology has a longstanding history rooted in efforts to reduce air pollution caused by industrial processes and combustion engines. The recognition of NOx as a significant environmental pollutant gained prominence in the mid-20th century, prompting research into effective control methods. Early approaches primarily focused on catalytic reduction and exhaust gas treatment, but these methods often faced limitations in efficiency and applicability across different sources. As environmental awareness increased, the need for more targeted absorption techniques became evident, leading to the exploration of chemical scrubbing and adsorption methods specifically designed for NOx removal.

The development of nitrogen oxides absorption technology advanced considerably during the 1960s and 1970s, driven by stricter emission regulations and the rise of environmental activism. Researchers began experimenting with various absorbents, such as aqueous solutions of alkali or alkaline earth metals, which could chemically react with NOx to form stable compounds. These early systems often relied on wet scrubbing processes, where flue gases were brought into contact with these absorbents in scrubbers. Despite initial challenges related to efficiency and byproduct management, these efforts laid the groundwork for more sophisticated absorption systems that could be integrated into industrial facilities and power plants.

In subsequent decades, technological innovations focused on optimizing absorption processes for greater efficiency and environmental compatibility. The introduction of selective catalytic reduction (SCR) and non-selective catalytic reduction (NSCR) techniques provided complementary methods to convert NOx into nitrogen and water, but absorption remained a vital component for capturing residual NOx. Advances in absorbent materials, such as activated carbon, zeolites, and specialized liquid absorbents, improved capacity and selectivity. Additionally, the development of regenerative absorption systems, which could reuse absorbents and minimize waste, marked a significant step forward in making NOx control more sustainable and cost-effective.

Today, nitrogen oxides absorption technology continues to evolve with a focus on environmental sustainability and operational efficiency. Modern systems often combine absorption with other emission control methods, such as catalytic reduction and electrostatic precipitators, to achieve comprehensive pollutant removal. Innovations in absorbent materials, including nanomaterials and advanced composites, aim to enhance adsorption capacity and reduce energy consumption. As regulatory standards tighten globally, ongoing research and development efforts are likely to yield even more advanced, eco-friendly absorption technologies that can effectively mitigate NOx emissions from a wide range of sources, contributing to cleaner air and a healthier environment.

### SUMMARY OF THE INVENTION

The present inventors used numerical optimization followed by experimental verifications to develop an optimized surface geometry of half-stepped cylinders that, when covered with a paint infused with titanium dioxide and exposed to UV radiation, reduces NOx levels by more than 25% in the presence of solar energy. Incorporating a forced air system can further increase the rate of NOx reduction by nearly 35%. A chemically reactive panel has been evaluated using a reactor with painted optimized surface geometry and is connected to a solar-powered suction fan that forces air over the surface for increased ambient NOx conversion. The system of the present invention is self-sustaining and can be placed at any location with a high concentration of ambient NOx for continuous NOx reduction during daylight hours. Using a transparent cover, the reactor utilizes sunlight and the chemically reactive panel to remove NOx from an airstream. The system is well suited to improve environmental conditions resulting from maritime commerce on air quality such as ambient NOx concentration in ports and harbors. Importantly, regulations enforcing remediation could be satisfied by using the present invention and result in improved local air quality.

### DESCRIPTION OF THE DRAWINGS

FIG. 1 is an elevated, perspective view of a close up view of the surface geometry of the panel;

FIG. 2 is an elevated, perspective view of a reactor for reducing NOx;

FIG. 3 is an exploded view of the reactor of FIG. 2;

FIG. 4 is a front view of the reactor of FIG. 2; and

FIG. 5 is another exploded perspective view of the reactor of FIG. 2.

### DETAILED DESCRIPTION OF THE PREFERRED EMBODIMENTS

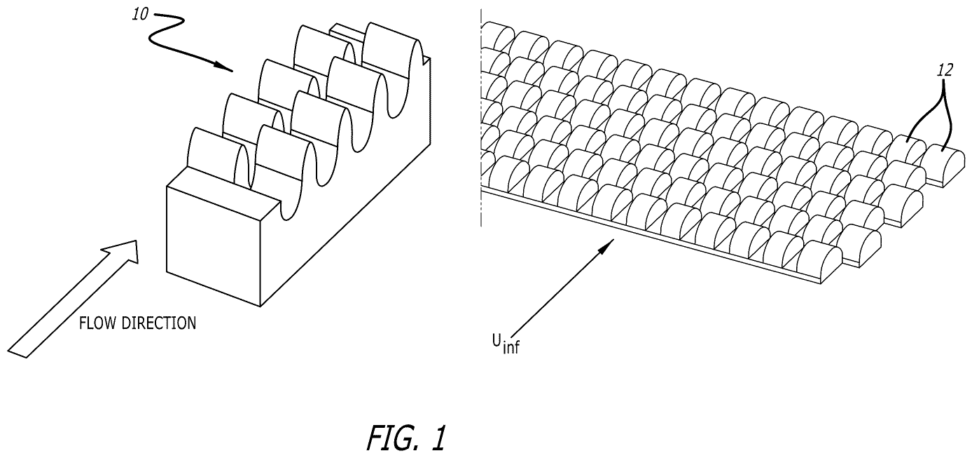

FIG. 1 shows a surface developed by computational analysis to maximize residency of the airflow over an undulating geometry to maximize the conversion of NOx. The surface shown in FIG. 1 incorporates a paint having titanium dioxide (TiO2) nanoparticles that, when it comes in contact with the NOx infiltrated airflow reduce the ambient NOx concentration for passive control and filtration of the ambient NOx. The behavior of TiO2 nanoparticles can change when a mixture of NO and NO₂ is present, and a higher NO₂/NOx ratio negatively impacts the effectiveness of the photocatalytic process. The maximum photodegradation rate is found at 25% relative humidity.

Surface porosity and distribution of the TiO2 on a surface along with residence time (exposure time) play major roles in the effectiveness of the surface absorption using the paint with TiO2 for reducing the ambient NOx. Increasing residence time can be enhanced by the development of a surface texture where air could be trapped, recirculated, and stalled to increase the time for chemical reaction and further reduction in NOx concentration. For example, within an urban canopy, flow around structures ranged from still air and low-speed natural convection to highly turbulent flows, and surface textures impact flow conditions at and near the surface within the boundary layer.

For the present invention, an AI-assisted numerical optimization was used to identify a surface geometry where air circulation was increased when forced air flowed over the surface at low speeds. FIG. 1 shows the optimized surface geometry 10 of repeating, half-stepped cylinders 12, in offset rows, that was determined to have the greatest absorption. That is, each adjacent row is a half period advanced from the previous row to create the undulating surface of cylindrical peaks and valleys.

The surface 10 shown in FIG. 1 was tested for both parallel flow and normal flow configurations and at 2× and 5× magnifications of the optimized dimensions. For natural convection, the 5× configuration with 7% infused TIO 2 paint showed 4.7% and 10.3% increase in NOx reduction for respectively parallel and perpendicular configurations when compared with the corresponding results for a flat surface, and increasing the TIO2 concentration to 20% improved the rate of conversion to a maximum of over 21%. Natural convection may limit the NOx reduction to the layers of air near the surface, and no significant ambient NOx reduction could be obtained through these processes. Testing included a mild air/pollutant mixture and the results showed the rate of reduction increased to nearly 35%, with a substantial volume of air exposed to the surface inside the reactor, making it a unique system for ambient NOx sequestration. The present invention resulted in a self-sustained system that uses a solar-powered fan to force ambient air over the surface inside the reactor for continuous NOx reduction.

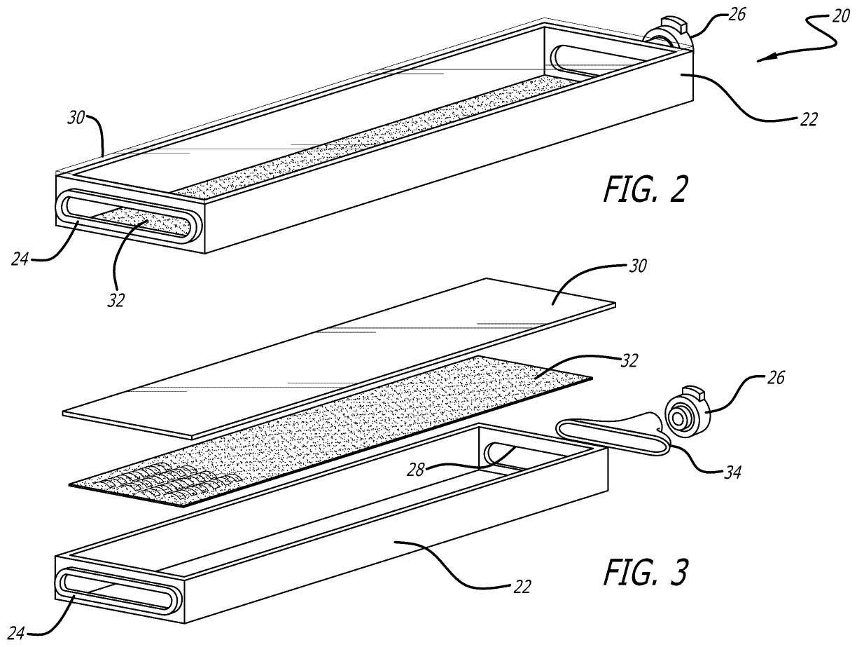

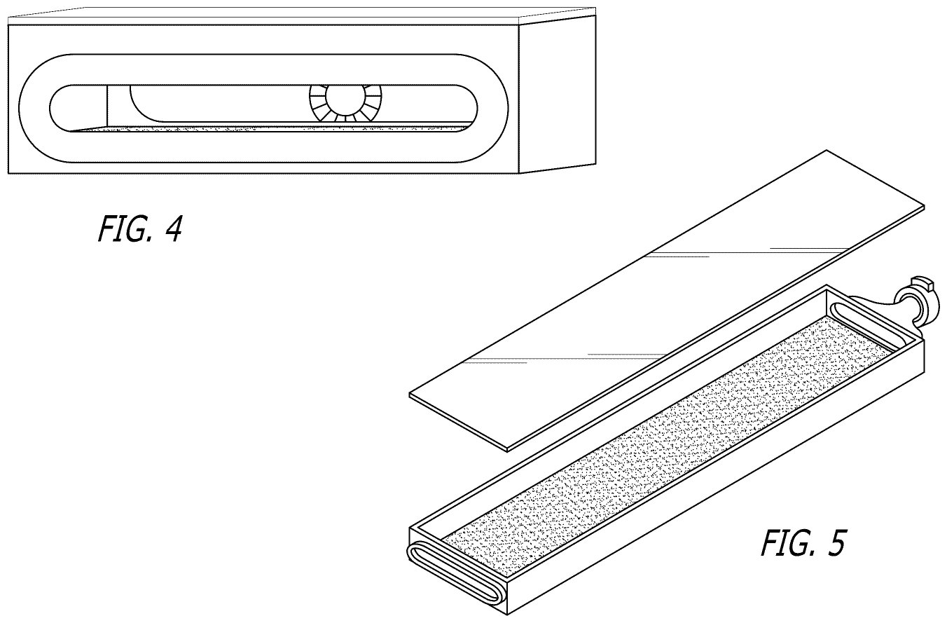

An embodiment 20 of the present invention (FIG. 2-5) includes a reactor comprising a housing 22 with an air inlet 24 and an solar-powered fan 26 at an air outlet 28 to create a forced air flow through the housing 22. The upper cover 30 is transparent to transmit sunlight, which aids in the chemical reaction. The reactor includes a panel 32 that comprises the optimized repeating half-stepped cylinder geometry, with the surfaces coated with a 20% TiO2-infused paint and connected to a solar-powered suction fan that allows flowing of ambient air over the surface. The solar-powered fan 26 uses solar energy to power the fan and results in a self-powered reactor (during daylight) that forces air through the reactor and absorbing the NOx constituents in the airstream.

With sun UV radiation exposure from the transparent cover 30, a chemical reaction within the reactor reduces ambient NO and NOx overall. One embodiment comprises a housing that is 1 m in width, 2 meters in length, and 0.15 meters in height. The bell-shaped mouth inlet 34 allows uniform air suction with minimum loss from the surroundings and the narrowness of the intake forces air through the optimized half-stepped cylinder surface for maximum reaction. The air through the suction fan diffuses further away from the intake. The system is self-sustained and operates with sunlight.

The present invention is not confined to the foregoing descriptions and depictions, as there are many variations and substitutions that a person of ordinary of ordinary skill in the art would readily recognize and appreciate. Nor are the drawings necessarily to scale, as the relative height and shape of the repeating protuberances can vary from embodiment to embodiment. The scope of the invention is intended not to be limited but to include all such variations and substitutions.

We claim:

1. A reactor for removing NOx from an airstream, comprising:
a housing having an air inlet, an air outlet, and a transparent cover for transmitting sunlight into the housing;
a solar-powered fan and intake conduit disposed at the air outlet for drawing air through the housing;
a panel extending the length of the housing, the panel comprises rows of repeating half-cylinders, each row offset from an adjacent row by a diameter of said cylinders;
wherein the panel is coated with a paint comprising titanium dioxide (TiO2) nanoparticles.
